(19) United States
(12) Patent Application Publication
(10) Pub. No.: US 2007/0014653 A1
(43) Pub. Date: Jan. 18, 2007

(54) System and method for use in completing a well

(76) Inventors: Scott Glenn, Hurricane, WV (US); Lars R. Halvorsen, Charleston, WV (US); Kirby Jon Walker, Clarksburg, WV (US)

Correspondence Address: SCHLUMBERGER TECHNOLOGY CORPORATION, IP DEPT., WELL STIMULATION, 110 SCHLUMBERGER DRIVE, MD1, SUGAR LAND, TX, 77478, US

(21) Appl. No.: 11/182,259

(22) Filed: Jul. 15, 2005

(51) Int. Cl. B60P 1/04

(52) U.S. Cl. 414/467

(57) ABSTRACT

A technique is provided to limit the number of vehicles required during a well project involving a plurality of well construction related procedures. The technique utilizes a transport vehicle able to receive a plurality of equipment modules that may be used for specific well related procedures. The modules may be interchanged with other vehicles for performance of specific procedures corresponding to specific modules.

### BACKGROUND

In many well projects, a large number of well related vehicles and equipment are used at a well site to complete various procedures related to well construction. Well projects may require, for example, cementing equipment, wireline equipment, acid injection equipment and other types of equipment for numerous potential procedures. Typically, each type of equipment is mounted on its own vehicle or set of vehicles and operated by a crew dedicated to that particular type of equipment.

Preparation of the area around the wellhead often is dictated by the number and size of equipment required for a given project. Each vehicle type and corresponding crew must have sufficient room at the well site to access the well during its specific procedure. In some projects, downtime can occur while waiting for the arrival of crews to handle specific procedures in a desired sequence during the well construction project.

### SUMMARY

In general, the present invention provides a system and method of facilitating completion of well related projects. A modular well construction approach is utilized to provide flexibility that enables a reduction in the amount of equipment and number of crews, thus creating greater efficiency in well projects. The equipment used for various procedures in well projects is constructed in modules that can be loaded on a support vehicle, such as a crane truck. The support vehicle has docking units that enable the mounting of a plurality of the equipment modules onto the vehicle for transport from one well site to another. Modules for a given procedure can be interchanged to enable performance of the specific procedure, thereby eliminating the need for a separate vehicle and crew dedicated to each procedure.

### BRIEF DESCRIPTION OF THE DRAWINGS

Certain embodiments of the invention will hereafter be described with reference to the accompanying drawings, wherein like reference numerals denote like elements, and:

FIG. 1 is a schematic top view of a well site with components to facilitate a well related procedure, according to an embodiment of the present invention;

FIG. 2 is a side view of a vehicle having a plurality of interchangeable modules, according to an embodiment of the present invention;

FIG. 3 is a another side view of the vehicle illustrated in FIG. 2 with different modules attached, according to an embodiment of the present invention;

FIG. 4 is a another side view of the vehicle illustrated in FIG. 2 with different modules attached, according to an embodiment of the present invention;

FIG. 5 is a flow chart illustrating a methodology for moving the interchangeable modules to other vehicles;

FIG. 6 is a flow chart illustrating a methodology for retrieving and loading modules on a transport vehicle upon completion of a given procedure, according to an embodiment of the present invention; and

FIG. 7 is a detailed side view of a crane vehicle that may be used with the system illustrated in FIG. 1.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to well projects in which various well procedures, e.g. services, are performed. Well equipment modules are used to perform multiple well related procedures, such as well construction procedures. The modules can be interchanged from one vehicle, e.g. a transport vehicle, to another vehicle, thus reducing the number of equipment carrying vehicles required for a given well project. The system also enables a reduction in the number of crew members while providing easy transportability of equipment from one well site to another.

Specifically, the system and methodology comprise a transport vehicle that may be in the form of a crane truck to transport the modules between well sites. The use of individual modules and a vehicle able to transport a plurality of the modules increases the efficiency and reduces the costs incurred during many types of well construction and other well related projects.

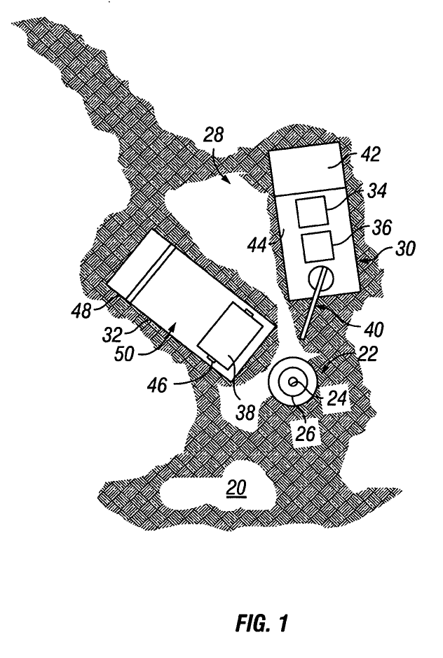

Referring generally to FIG. 1, a top view of a well site 20 is illustrated. In this example, a well 22 is undergoing a well procedure, e.g. a well construction procedure, and generally comprises a wellbore 24 extending downwardly from a wellhead 26 into a subterranean formation containing desired production fluids, such as hydrocarbon based fluids. In many projects, wellbore 24 is drilled into an oil bearing formation for the production of oil. Additionally, only one well 22 is illustrated, but a given project may comprise multiple wells that undergo various well related procedures. It also should be noted that certain well related procedures can be performed on new or existing wells.

As illustrated in FIG. 1, a modular support system 28 is used in a variety of well related projects. In this embodiment, modular system 28 comprises a support vehicle 30 that may be positioned at well site 20 for cooperation with at least one other support vehicle 32. By way of example, support vehicle 30 comprises a road-legal transport vehicle that can be driven over the regional roads from one well site to another. Support vehicle 32 also is a road-legal vehicle utilized in well completion procedures or other well related procedures.

The modular support system 28 further comprises a plurality of equipment modules, such as modules 34, 36 and 38. The modules, e.g. modules 34, 36 and 38, comprise equipment used in a variety of well related procedures. Previously, each type of equipment would be dedicated to a specific vehicle and operated by a specific crew. However, equipment modules 34, 36 and 38 are interchangeable and can be moved from one vehicle, e.g. support vehicle 30, to another vehicle, e.g. support vehicle 32, as needed for performing specific well related procedures. A given module typically is designed for a specific phase of the well project, e.g. cementing, acid application, logging.

In the example illustrated, support vehicle 30 comprises a crane truck having a crane 40, a cab 42 and a storage area 44 for storing a plurality of modules. The modules may be selectively released and removed from storage area 44 by crane 40 and moved into a desired position for operation of the equipment contained in the module to accomplish a specific well related procedure. For example, crane 40 can be used to move specific modules from crane truck 30 to support vehicle 32 where the module is selectively mounted to support vehicle 32 via a mounting mechanism 46. Mounting mechanism 46 is designed to enable the easy connection and disconnection of each module 34, 36 and 38. The specific modules are selected for facilitating each unique phase of well construction. For example, the series of modules may be mounted to mounting mechanism 46 in a specific sequence to facilitate the sequential phases of well construction. Mounting mechanism 46 can comprise a variety of designs, including mechanical catch and release mechanisms, fasteners, e.g. bolts, hydraulically actuated locks or other mechanisms that enable the relatively rapid mounting of the module, disconnection of the module, and mounting of a subsequent module according to the desired sequence of well construction procedures for a given project.

Support vehicle 32 may comprise a variety of other features depending on the specific uses for which the vehicle is designed. For example, vehicle 32 may comprise a cab 48 and a permanent equipment area 50. Permanent equipment area 50 may be designed to accommodate many types of equipment, including a fixed cement mixing and pumping unit to facilitate, for example, cementing of liners and other well construction procedures.

In the example illustrated, modules 34, 36 and 38 are delivered to well site 20 by crane truck 30 and support vehicle 32. Crane truck 30 is used to carry two modules, although the vehicle may be designed to carry other numbers of modules depending on the size and type of equipment incorporated into the interchangeable modules. Once at well site 20, crane 40 is used to move modules 34, 36 and 38 to desired locations. For example, modules can be sequentially released and lifted from support vehicle 32 after completion of each procedure utilizing a specific module. Upon completion of the specific procedure, crane 40 is used to lift the next sequential module from crane truck 30 and to move that module into engagement with support vehicle 32 where it is secured by mounting mechanism 46 for use in the next sequential well related procedure. This process can be continued by interchanging modules, thereby allowing a minimal number of vehicles and crews to accomplish many well related procedures for a given well project. In the example illustrated in FIG. 1, at least three interchangeable modules for three unique procedures of well construction can be carried by two support vehicles.

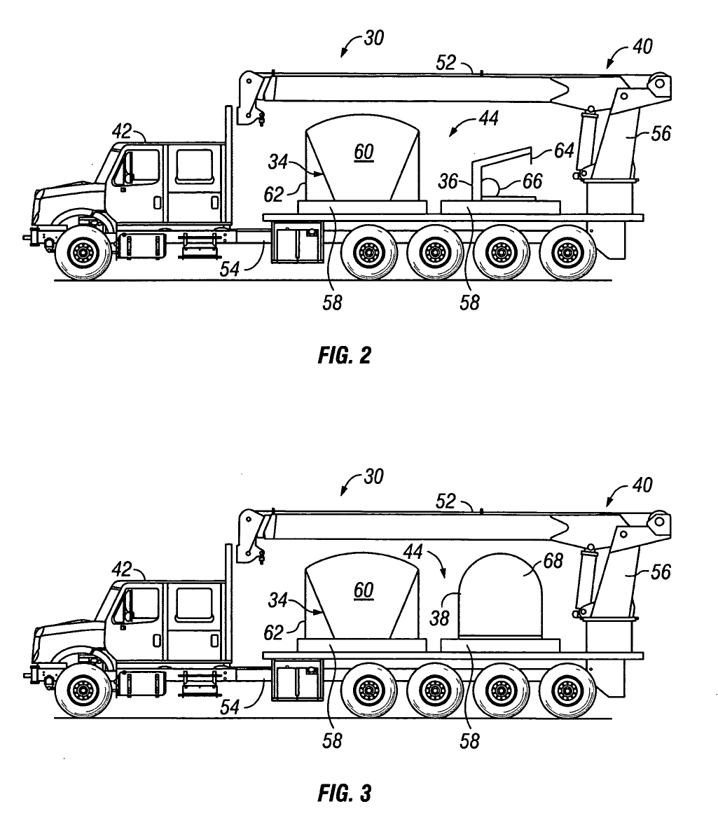

Referring generally to FIGS. 2-4, examples of several configurations for vehicle 30 are illustrated. As illustrated, vehicle 30 generally comprises a crane truck having crane 40 formed of a boom 52 pivotably mounted to a vehicle chassis 54 via a crane base 56. Various configurations of modules can be removably mounted to chassis 54 in storage area 44 via a plurality of docking units 58. Docking units 58 can comprise a variety of designs, including mechanical catch and release mechanisms, fasteners, e.g. bolts, hydraulically actuated locks or other mechanisms that enable the relatively rapid mounting of each module, disconnection of each module, and subsequent mounting of the same or different modules for transport or later use in a given well related project.

Numerous arrangements of modules can be mounted in storage area 44 depending on the procedures required for a given well project. As illustrated in FIG. 2, crane truck 30 may be used to carry modules 34 and 36 in the form of a cement bulk module 34 and a wireline module 36. Cement bulk module 34 is used for supplying bulk material to cement mixing and pumping equipment which is provided at the well site, and may be mounted on a vehicle, e.g. mounted in equipment area 50 of support vehicle 32. Cement bulk module 34 comprises a bulk material holding tank 60 mounted on a support framework 62 that may be readily connected and disconnected from docking unit 58. Instead of supplying bulk material via a separate truck, module 34 is simply lifted from vehicle 30 by crane 40 and moved to a desired position at well site 20 for carrying out the cementing procedure. For example, the cement bulk module 34 can be mounted on support vehicle 32 via mounting mechanism 46. Upon completion of the cementing process, module 34 may be disconnected and removed from mounting mechanism 46 to enable the interchanging of module 34 with another module.

Wireline module 36 comprises, for example, a wireline 64 and a wireline winch 66 for moving wireline 64 into wellbore 24. Wireline module 36 can be used for a variety of well construction related procedures, including the logging of data from within the well. Accordingly, wireline module 36 can be released from its docking unit 58 and lifted from vehicle 30 via crane 40 for movement to a desired position of operation, e.g. mounting mechanism 46 on support vehicle 32. Upon completion of this phase of well construction, module 36 is moved back to one of the docking units 58 on crane truck 30 or to another storage location.

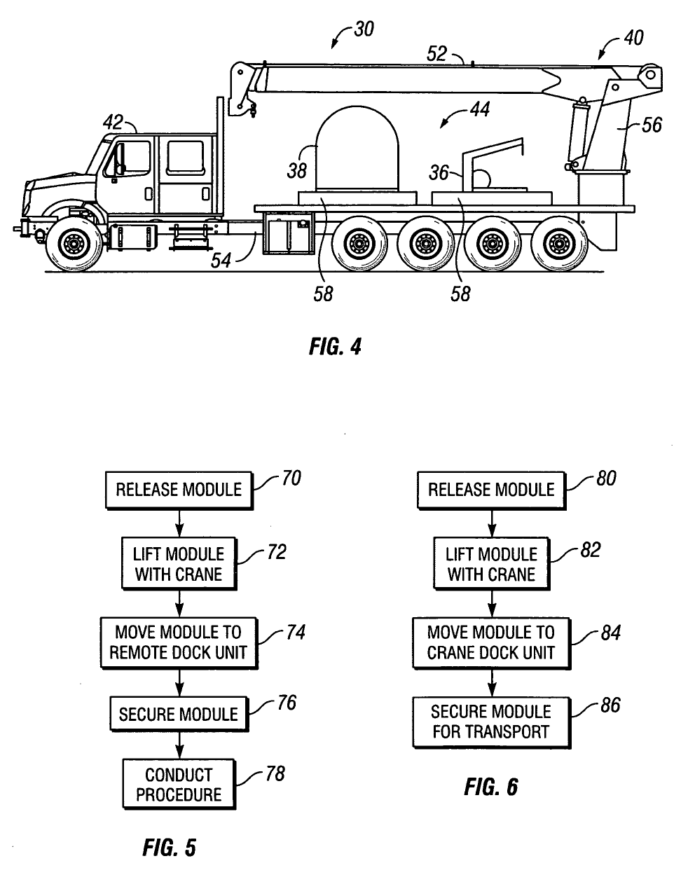

Referring generally to FIG. 3, another configuration of crane truck 30 is illustrated. In this embodiment, modules 34 and 38 are mounted to two docking units 58. As discussed above, module 34 may comprise a cement bulk module, and module 38 comprises equipment dedicated to a different well related procedure. In the example illustrated, module 38 comprises an acid bulk module having an acid tank 68 for holding acid that is used in acid treatment procedures within well 22. When an acid treatment procedure is desired, module 38 simply is released from its docking unit 58 and lifted to an appropriate operational position by crane 40. In another example, crane truck 30 is loaded with modules 36 and 38 in the form of a wireline module, and an acid bulk module, as illustrated best in FIG. 4.

In operation of crane truck 30 at well site 20, individual modules are selected and utilized in specific well related procedures, as generally set forth in the flowchart of FIG. 5. Initially, the module, e.g. module 34, 36 or 38, is released from its corresponding docking station 58, as illustrated by block 70. The module is then lifted from vehicle 30 by crane 40, as illustrated by block 72. Boom 52 of crane 40 is then used to move the module to a remote docking unit, such as mounting mechanism 46 positioned on support vehicle 32, as illustrated by block 74. The module is then secured in an operational position, as illustrated by block 76. Once securely attached, the appropriate well related procedure, e.g. cementing procedure, logging procedure or acid injection procedure, associated with that specific equipment module is carried out at the well site, as illustrated by block 78.

Upon completion of the specific procedure, the module can be moved to an appropriate storage location. According to one embodiment, the module is returned to one of the docking units 58 on crane truck 30, as illustrated by the flowchart of FIG. 6. Initially, the module is released from its operational position, as illustrated by block 80. Boom 52 is then moved into position over the module, and crane 40 is used to lift the module from its operational position, e.g. mounting mechanism 46, to make room for a subsequent equipment module, as illustrated by block 82. The module is then moved to one of the docking units 58 located on crane truck 30, as illustrated by block 84. At this stage, the module can be secured to its corresponding docking unit 58 for transport to another well site, as illustrated by block 86. It should be noted, however, that various other procedures and interchanges of modules can be accommodated by crane truck 30. Upon completion of the well project, crane truck 30 is used to transport the plurality of modules to another location, such as another well site for additional well construction or other well related procedures.

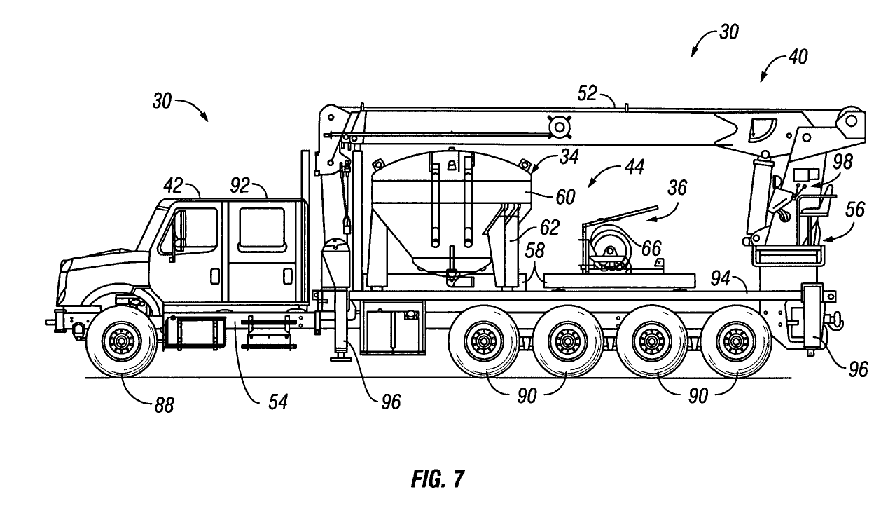

Referring generally to FIG. 7, a more detailed example of vehicle 30, in the form of a crane truck, is illustrated. In this embodiment, vehicle 30 is a road-legal crane truck having chassis 54 supported on front wheels 88 and rear wheels 90. As illustrated, rear wheels 90 are mounted on four axles. However, vehicle 30 may comprise other numbers of rear axles depending on the weight of the equipment carried as well as the regional regulations pertaining to use of vehicles on public roadways.

Cab 42 may be an extended cab having an extended sleeper or storage portion 92. The cab 42 is mounted on chassis 54, and crane 40 also is mounted on chassis 54 via a platform 94 to which crane base 56 is secured. In this embodiment, crane base 56 is mounted towards the rear of vehicle 30 and supports boom 52 and a transport position over the stored modules during transport of the modules from one well site to another. Also, a plurality of stabilizer mechanisms 96, such as hydraulic stabilizer arms, can be pressed against the ground to stabilize platform 94 during extension of boom 52 and movement of the modules. In the specific embodiment illustrated, storage area 44 is located on platform 94 between the crane base 56 and cab 42 and is sized to carry two modules, such as module 34 and module 36. Additionally, crane truck 52 comprises an external control console 98 by which an operator can control crane 40 and movement of modules from and to docking units 58. The overall design of crane truck 30 enables the movement of at least two separate equipment modules from one well site to another for use in a plurality of well procedures, thereby avoiding the need for separate vehicles and crews dedicated to each procedure type.

It should be noted that modular support system 28 may be used in a variety of configurations depending on the specific well project. For example, support vehicle 32 may comprise a variety of vehicle designs, and certain projects may incorporate the use of additional support vehicles that can be used in cooperation with the multi-module crane truck illustrated and discussed above. Various types of permanently affixed equipment, either mounted on vehicles or at the well site, also can be used for a given project. The size and functionality of the modules described above can be changed or adjusted according to the requirements of specific projects.

Accordingly, although only a few embodiments of the present invention have been described in detail above, those of ordinary skill in the art will readily appreciate that many modifications are possible without materially departing from the teachings of this invention. Accordingly, such modifications are intended to be included within the scope of this invention as defined in the claims.

What is claimed is:

1. A well support vehicle, comprising:
a modular crane truck having a chassis, a crane mounted on the chassis, and a plurality of docking units supported by the chassis to interchangeably receive modules related to well procedures.

2. The well support vehicle as recited in claim 1, further comprising a plurality of modules, each module being mountable to one docking unit of the plurality docking units.

3. The well support vehicle as recited in claim 2, wherein the plurality of docking units comprises two docking units and the plurality of modules comprises three modules.

4. The well support vehicle as recited in claim 2, wherein the plurality of modules comprises a cement bulk module.

5. The well support vehicle as recited in claim 2, wherein the plurality of modules comprises a wireline module.

6. The well support vehicle as recited in claim 2, wherein the plurality of modules comprises an acid bulk module.

7. The well support vehicle as recited in claim 1, wherein the modular crane truck comprises a road legal truck.

8. The well support vehicle as recited in claim 7, further comprising a cab mounted on the chassis, wherein the crane is mounted on the chassis via a crane base, and the plurality of docking units are positioned between the cab and the crane base.

9. The well support vehicle as recited in claim 8, further comprising a pair of modules mounted to the plurality of docking units.

10. An apparatus for use in well related procedures, comprising:
a road legal vehicle having:
a chassis;
a cab mounted to the chassis;
a crane mounted to the chassis via a crane base; and
a plurality of interchangeable equipment modules removably mounted to the chassis.

11. The apparatus as recited in claim 10, wherein the plurality of interchangeable equipment modules are mounted between the cab and the crane base.

12. The apparatus as recited in claim 10, wherein the plurality of interchangeable equipment modules are positioned for removal from the chassis by the crane.

13. The apparatus as recited in claim 11, wherein the plurality of interchangeable equipment modules comprises a cement bulk module.

14. The apparatus as recited in claim 13, wherein the plurality of interchangeable equipment modules comprises a wireline module.

15. The apparatus as recited in claim 13, wherein the plurality of interchangeable equipment modules comprises an acid bulk module.

16. The apparatus as recited in claim 11, wherein the plurality of interchangeable equipment modules comprises a wireline module and an acid bulk module.

17. A system for completing wells, comprising:
a plurality of modules designed to perform a plurality of procedures related to completing a well, the plurality of modules being removably mountable to a plurality of vehicles; and
a transport vehicle having docking stations to which modules of the plurality of modules may be removably mounted for transport between well sites.

18. The system as recited in claim 17, wherein the transport vehicle is a crane truck.

19. The system as recited in claim 18, wherein the plurality of modules comprises a cement bulk module and a wireline module.

20. The system as recited in claim 18, wherein the plurality of modules comprises a cement bulk module and an acid bulk module.

21. The system as recited in claim 18, wherein the plurality of modules comprises a wireline module and an acid bulk module.

22. A method, comprising:
providing a plurality of modules for use at a well site to perform a plurality of well construction procedures; and
removably mounting the plurality of modules to docking units on a crane truck.

23. The method as recited in claim 22, wherein removably mounting comprises lifting the plurality of modules to the docking units with a crane of the crane truck.

24. The method as recited in claim 23, further comprising forming each docking unit to interchangeably receive a plurality of different modules.

25. The method as recited in claim 23, further comprising utilizing the crane to lift each module of the plurality of modules to a separate well related vehicle.

26. The method as recited in claim 22, wherein removably mounting comprises removably mounting a cement bulk module on the crane truck.

27. The method as recited in claim 22, wherein removably mounting comprises removably mounting a wireline module on the crane truck.

28. The method as recited in claim 22, wherein removably mounting comprises removably mounting an acid bulk module on the crane truck.
